(19) United States
(12) Patent Application Publication
(10) Pub. No.: US 2023/0311019 A1
(43) Pub. Date: Oct. 5, 2023

(54) Interactive Reading System

(71) Applicant: International Publishing Services Pty Ltd., Dee Why (AU)

(72) Inventor: Wayne McKay, Dee Why (AU)

(21) Appl. No.: 18/192,538

(22) Filed: Mar. 29, 2023

Related U.S. Application Data
(60) Provisional application No. 63/326,550, filed on Apr. 1, 2022.

(51) Int. Cl. A63H 33/38; G06F 3/04886

(52) U.S. Cl. CPC A63H 33/38; G06F 3/04886; A63H 2200/00

(57) ABSTRACT

An interactive reading system and method thereof that includes a book having opposite book covers, a plurality of pages between the book covers; a device integrated into one of the covers of the book to record and play audio messages. The device including a control module; a keyboard connected to the control module; an audio input connected to the control module for recording the audio messages; a speaker connected to the control module for playing the recorded audio messages; a headphone connected to the control module; and a memory connected to the control module. The device enabled for receiving, storing, and playing audio information.

### CROSS REFERENCE TO RELATED APPLICATIONS

This application claims the benefit of priority to U.S. Provisional Application No. 63/326,550, filed Apr. 01, 2022, entitled AN INTERACTIVE READING SYSTEM, the contents of which are incorporated herein by reference.

### TECHNICAL FIELD

The present invention relates to storybooks, in particular, to storybooks containing an interactive reading device for recording and playing stories.

### BACKGROUND

In recent years, reading devices for books have achieved extraordinary popularity.

For example, the prior art shows an interactive picture book with voice recording functions and method of use. The device includes a combination of a storybook and a separate audio recorder adapted for mounting on the storybook. The recorder can be used with any of several storybooks by recording the story of each book by the buyer for a child to play back later. Buttons corresponding to the various pages of the storybook are provided so that a child can correlate a button to each page to listen to the story and read it. Dual recording devices can be played back simultaneously where one can provide background music or sound, while the other provides an audio representation of the text or any audio desired by the user.

In addition, the prior art shows a handheld e-book reader with annotations and usage tracking capability. A handheld e-book reader, a program product, and a method incorporates enhanced usage tracking and/or annotation capabilities. Users can create “contexts” for terms defined in an electronic document.

Furthermore, the prior art shows a display system for reading a book electronically, which basically describes an information display system having a housing with a location to receive a document such as a book. A location sensing circuit is mounted in the casing adjacent to the document and can determine any subjective selection of a location on the document.

In addition, the prior art shows an electronic book reader and an electronic book reading program for a device having network connectivity capability. The program includes a voice annotation function that allows the user reading an e-book to highlight the selected text and record a voice annotation related to that highlighted material. The highlighted text and the related (linked) voice annotation are saved as a “Voice Memo” file, which the user can review, sort, or delete as desired, said document, although it mentions that a voice memo can be recorded.

None of the above-indicated products offer, include, incorporate, disclose, teach, suggest, show, or otherwise render obvious, either alone or in combination, the invention described herein.

### SUMMARY OF THE INVENTION

The present invention relates to a device that can be integrated into the cover of a book, in such a way that a first user can record his voice and assign the recording to a particular page number, in such a way that the first user, that can be a parent or a caregiver, can record his voice reading a story adding comments as he wishes, assigning said recording with a specific page number so that a second user, who could be a child or a patient, can play the recording as he wishes and follow him/her in the book so that parents/caregivers can read to their children/patients even when they are absent.

An interactive reading system having a book including a first book cover and a second book cover, the first book cover is located opposite to the second book cover; a plurality of pages located between the first and the second book covers; an interactive reading system integrated into a cavity on the first book cover or the second book cover; the interactive reading system comprises on a first side: a control module; a keyboard connected to the control module; an audio input device connected to the control module for recording the audio messages; a speaker connected to the control module for playing the recorded audio messages; a headphone connected to the control module; a memory connected to the control module; the device enabled for receiving, storing, and playing audio information.

### BRIEF DESCRIPTION OF FIGURES

FIG. 1 shows the interactive reading system device of the present invention incorporated into a storybook;

FIG. 2 shows a block diagram showing the internal components on a first side of the interactive reading system according to the present invention;

FIG. 3A shows a perspective rear view of the interactive reading system according to the present invention;

FIG. 3B shows a perspective front view of the interactive reading system according to the present invention;

FIG. 3C shows a detailed view of the front side of the interactive reading system of FIG. 3B;

FIG. 3D shows a detailed view of the back side of the interactive reading system of FIG. 3A;

FIG. 3E shows a cross sectional view taken along Line A-A′ of the interactive reading system of FIG. 3D; and

FIG. 4 shows a diagram of the electronic circuit board of the interactive reading system according to the present invention.

### DESCRIPTION OF THE INVENTION

From now, reference will be made to the details of the construction of the invention presented, showing details of exemplary embodiments, which are illustrated in the attached drawings. In the following descriptive memory, the implementation of preferred embodiments of the invention is taught, however, does not represent all the preferred modalities of the invention, since the present invention can be used in combination with other objects that are not books, where is desired to present information to a second user, or record reminders or messages to said user.

The terminology used in the present specification is only to describe particular embodiments and is in no way intended to limit the present disclosure. In the same way, the figures presented are only to show said modalities and are not intended to teach limitations of the invention.

The present invention relates to an interactive reading system integrated into a book cover which stores recorded spoken texts corresponding to texts printed on pages of the book and an audio device that plays back the recorded text.

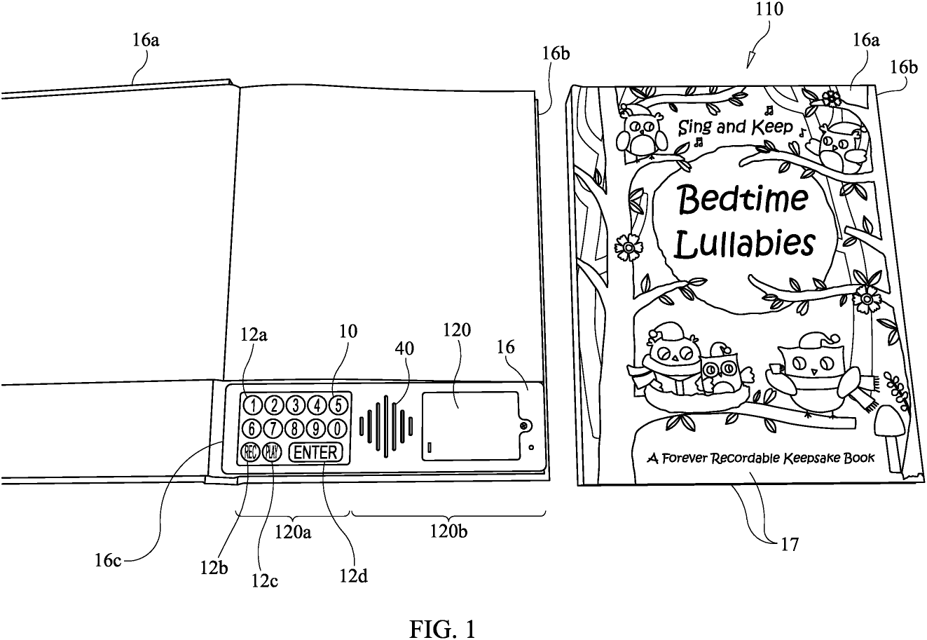

As shown by FIG. 1, the interactive reading system 120 includes a book 110 having a first book cover 16a and a second book cover 16b, the first book cover 16a is located opposite to the second book cover 16b, a plurality of pages 17 located between the first and the second book covers 16a, 16b, the plurality of pages include text and pictures thereon; an interactive reading system 120 is integrated into a cavity 16c which can be located on the first book cover 16a or the second book cover 16b of the book to record and play audio messages.

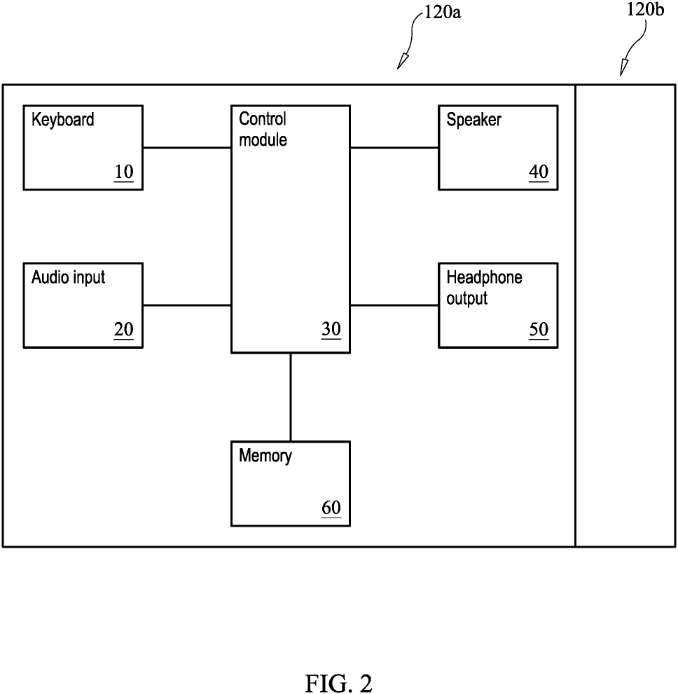

FIG. 2 shows the block diagram showing the internal components on a first side 120a of the interactive reading system 120 according to the present invention. The interactive reading system 120 including an electronic circuit having on a first side 120a a control module 30; a keyboard 10 connected to the control module 30; an audio input device 20 connected to the control module 30 for recording the audio messages; and a memory 60 connected to the control module 30. The interactive reading system 120 is enabled for receiving, storing, and playing audio information.

On a second side 120b, the internal side of the interactive reading system 120 includes a compartment 80 adapted to house batteries (not shown), a speaker 40 connected to the control module 30 to play the recorded audio messages, and optionally an audio output device 50 connected to the control module 30.

The control module 30 provides interconnection with, and use of, all the components of the interactive reading system 120. The control module 30 receives the recording from the audio input device 20 and stores the recording in the memory 60.

The control module 30 may be, but not limited to, a processor, a microcontroller, logic circuits, or any other circuit known in the state of the art. The control module 30 includes a software program designed to allow reading, recording, and retrieving the selected audio and visual information.

The audio input device 20 allows to record the information dictated by the first user, illustrated on the pages 17 of the book 110. The recording may be made by the first user. In one embodiment, audio input device 20 may have a prerecorded background music and the first user may record the reading over the background music.

The audio input device 20 may be any commercially available audio input device, for example, but not limited to, a microphone.

The speaker 40 is the component through which the narration of the book or recorded voice messages is heard.

In one embodiment, the book pages 17 may include an interactive region therein. Touching the interactive region may cause either the storing of the audio information in the memory about the recording audio by the first user or the retrieving of the recording audio file from the memory by the second user.

The keyboard 10 includes several keys 12a-12d that correspond to specific functions of the system 120. The several keys 12a-12d allows the user to choose the page number and through the electrical circuit initiate the recording of the audio information corresponding to a portion of a story written on the corresponding one of the pages 17 of the storybook 110. The keyboard 10 also allows the second user to select a page number where he/she wants to listen to the narration of the book or the voice messages left by the first user. The keyboard 10 may be any commercially available keyboard that fits inside the housing 90 on the book cover 16 of the book 110. The keyboard 10 has several keys 12a with digits 0 to 9. In addition, the keyboard 10 includes a recording key 12b, a play key 12c, and an enter key 12d. The user may enter the desired page to capture by entering a two-digit number, for example, for page 1, the user may enter 01.

In one embodiment, the keyboard may be a touch screen.

In one embodiment, the keyboard 10 may include a switching button (not shown) to select between the recording mode and the playback mode.

In one embodiment, the keyboard 10 may include a lock button (not shown) that when activated, prevents the loss of recorded information through recording over it. The lock buttons are well known in the art.

The memory 60 stores the recorded information from the user. The memory 60 may be any commercially available memory used to store data and music. In one embodiment, the memory 60 may be a random-access memory (RAM).

The control module 30 waits for the selection from the user on the keyboard 10 about the desired page number to listen to the narration of the book or the voice messages made by the first user and that is stored in the memory 60.

The audio output device 50 includes a headphone outlet for directing the audio information to a headphone (not shown). The audio output device 50 allows the recorded audio information/reading to be heard through a speaker or similar device.

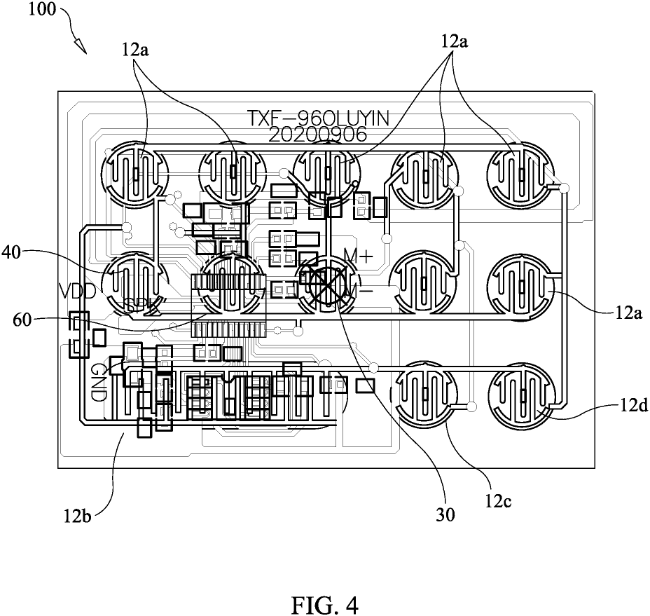

FIG. 4 shows the diagram of the electronic circuit board 100 according to the present invention.

In an embodiment, the interactive reading system 120 may include a visual recording device (not shown), for example, a camera to record the first user (parent) when reading the book; thus, the second user (child) may see the first user’s facial expressions through a display screen (not shown).

The user may record the audio text in the language of their choosing, established by the book.

The present invention also relates to a method for recording a reading audio of a text taken from a book and then playing back the recorded message to a further user, the method comprising the steps of:
providing a book having a first book cover and a second book cover, the first book cover is located opposite to the second book cover; a plurality of pages located between the first and the second book covers; an interactive reading system integrated into a cavity on the first book cover or the second book cover; wherein the interactive reading system comprises a housing having on a first side: a control module; a keyboard connected to the control module; an audio input device connected to the control module for recording the audio messages; a memory connected to the control module; wherein the housing comprises on a second side: a speaker connected to the control module for playing the recorded audio messages; a compartment adapted to house batteries; a headphone connected to the control module; wherein the device enabled for receiving, storing, and playing audio information;
entering a password through the keyboard to select a recording mode;
selecting a page number on the book to start reading the book by using the required key on the keyboard;
starting to read the text on the selected page;
recording the reading text by pressing an enter key on the keyboard;
once the recording step is finished, pressing the enter key to save the recorded reading text in the memory; and
pressing the play key to enter the desired page number to retry the recorded message.

The process of recording the messages is carried out by entering a password through the keyboard 10 to select the recording mode and then pressing the enter key 12d. The password is a three-to-five-digit number. After the password is entered, the device 120 will produce a beep (long sound) through the speaker 40, indicating that the device is unlocked.

In order to configure the password, the user may press the recordation key 12b on the keyboard 10 and after hearing a long beep, then the user may press the enter key 12d constantly for 3 seconds, and immediately enter the desired password. If the password is configured correctly, a long beep is generated by the control module 30, confirming the password. In the event that within 10 seconds after entering the desired password the long beep is not heard, the user may need to repeat this step again.

The device has a combination of keys in case the user forgets their password, with this combination of keys, a new password can be reset, so the recordation key 12b+, the play key 12c, is pressed for 3 seconds, a long beep is generated by means of the control module 30, to then enter the new password. If a long beep is heard, it means that the new password was created successfully. In the event that the generation of the new password is not carried out, then 3 beeps are heard indicating that the process needs to be started again.

Once an inactivity of, for example, 60 seconds is detected by the control module 30, the interactive reading system 120 is locked again.

To start the recording, the user may press the recordation key 12b on the keyboard 10, and then the page number where the user wants the text to appear, then within three seconds, the user may press the enter key 12d to start the recording.

Once the recording is finished, the user may press the enter key 12d to save the recording in memory 60.

The user may repeat the above-indicated process as many times as desired to record the message on each desired page.

When the user wants to play the recording, the user may press the play key 12c and then a long beep will be heard on the speaker 40. Then, the user may be able to enter the page number that he/she wants to hear to start playing back the recorded message. The user may stop the playing of the message by just pressing play again.

In one embodiment, the first user may have the option to modify the previously-recorded audio text by pressing a specific code provided by the manufacturer. If the recorded audio text is satisfactory to the user, then, the latest version of the audio file remains in the memory 60 and the user may continue reading.

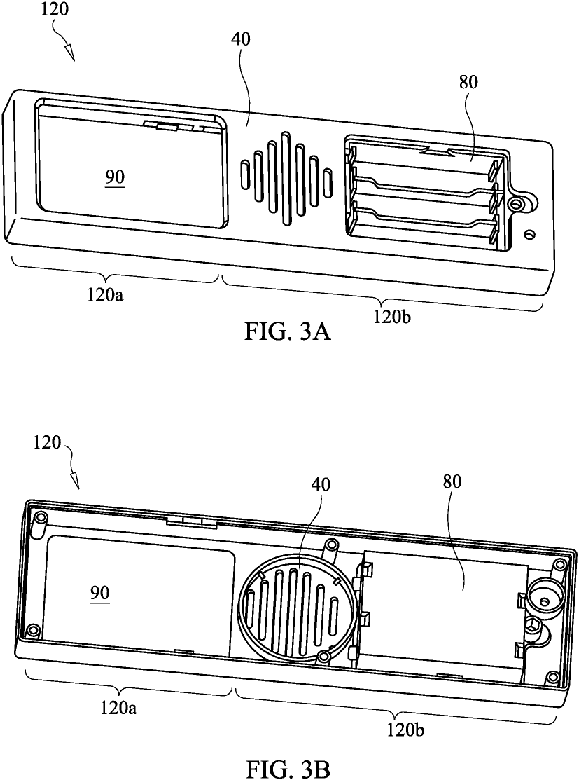

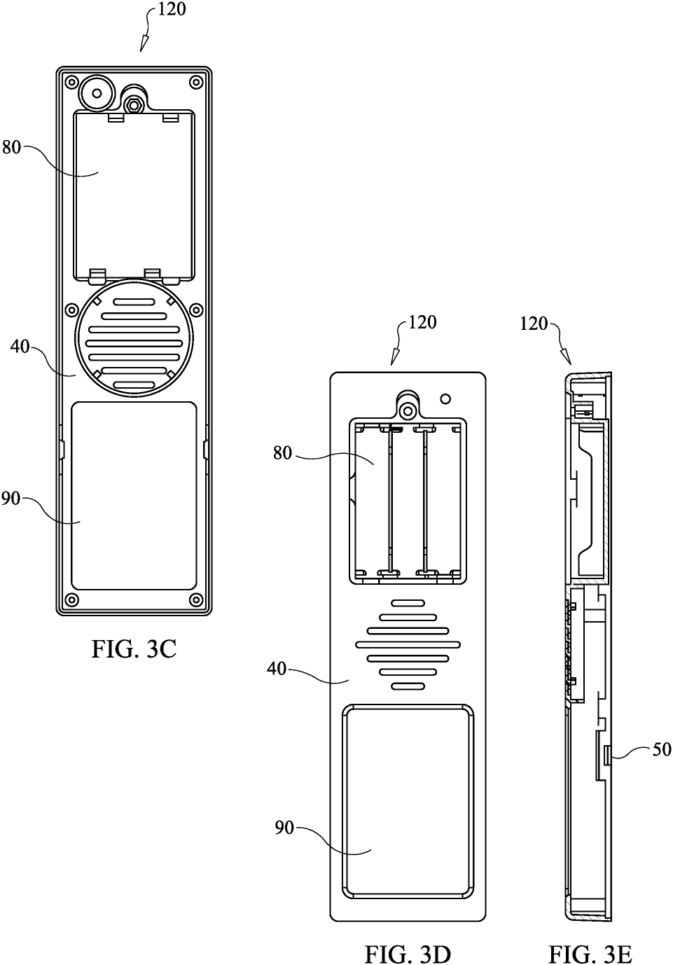

FIGS. 3A to 3E show the physical structure of the interactive reading system 120, where the physical dimensions of the interactive reading system 120 can be seen, as well as the location of a compartment 80 adapted to receive batteries (not shown), for power supply for the interactive reading system 120. It is also observed in a housing 90 for the keyboard 10 and electronic circuit board.

In addition, the interactive reading system 120 allows the user to program the desired length of the recording time. The software allows the user to pre-program the recording for a desired length on each recorded page specifically allowing to cater for more or less words per page.

Furthermore, the user may have the option to skip a page.

The software program can record only specific pages or as needed by the user. This is a critical pre-programming feature as it directs the user where to and where not to record when using the book.

With the foregoing, the preferred embodiments of the present invention have been described with reference to the attached figures; thus, without being limited to the foregoing, so that a person, with habit in the technical field of the invention, can modify or find alternatives that are within the proximity of the appended claims and it should be understood that they will naturally fall under the technical proximity of the present description.

1. An interactive reading system comprising:
a book having a first book cover and a second book cover, the first book cover is located opposite to the second book cover;
a plurality of pages located between the first and the second book covers;
an interactive reading system integrated into a cavity located on the book cover;
wherein the interactive reading system comprises a housing having on a first side:
a control module;
a keyboard connected to the control module;
an audio input device connected to the control module for recording the audio messages;
a memory connected to the control module;
wherein the housing comprises on a second side:
a speaker connected to the control module for playing the recorded audio messages;
a compartment adapted to house batteries;
a headphone connected to the control module;
wherein the device enabled for receiving, storing, and playing audio information.

2. The interactive reading system according to claim 1, wherein the audio input device is a microphone.

3. The interactive reading system according to claim 1, wherein the book pages include a touching interactive region.

4. The interactive reading system according to claim 1, wherein the plurality of pages of the book includes text and images.

5. The interactive reading system according to claim 1, wherein the keyboard is a touch screen.

6. The interactive reading system according to claim 1, further including a visual recording device.

7. The interactive reading system according to claim 1, wherein a password is required to access the system.

8. A method for recording a reading audio of a text taken from a book and then playing back the recorded message to a further user, the method comprising the steps of:
providing a book having a first book cover and a second book cover, the first book cover is located opposite to the second book cover; a plurality of pages located between the first and the second book covers; an interactive reading system integrated into a cavity on the book cover; wherein the interactive reading system comprises a housing having on a first side: a control module; a keyboard connected to the control module; an audio input device connected to the control module for recording the audio messages; a memory connected to the control module; wherein the housing comprises on a second side: a speaker connected to the control module for playing the recorded audio messages; a compartment adapted to house batteries; a headphone connected to the control module; wherein the device enabled for receiving, storing, and playing audio information;
entering a password through the keyboard to select a recording mode;
selecting a page number on the book to start reading the book by using the required key on the keyboard;
starting to read the text on the selected page;
recording the reading text by pressing an enter key on the keyboard;
once the recording step is finished, pressing the enter key to save the recorded reading text in the memory; and
pressing the play key to enter the desired page number to retry the recorded message.
